(19) United States
(12) Patent Application Publication
(10) Pub. No.: US 2010/0178791 A1
(43) Pub. Date: Jul. 15, 2010

(54) Electrical Connector

(75) Inventors: Ryuichi Komiyama, Tokyo (JP); Kazushige Sakamaki, Tokyo (JP)

Correspondence Address: BARLEY SNYDER, LLC, 1000 WESTLAKES DRIVE, SUITE 275, BERWYN, PA, 19312, US

(73) Assignee: TYCO ELECTRONICS AMP K.K., Kanagawa-ken (JP)

(21) Appl. No.: 12/525,183

(22) PCT Filed: Jan. 29, 2008
(86) PCT No.: PCT/JP2008/051307

§ 371 Date: Mar. 12, 2010

(30) Foreign Application Priority Data
Jan. 31, 2007 (JP) 2007-021149

(51) Int. Cl. H01R 13/639

(52) U.S. Cl. 439/347

(57) ABSTRACT

There is provided an electrical connector in which the retaining force of retaining a front cover is improved. Electrical connectors 1, and 1′ each have a housing 10 having contact accommodating cavities 13; a front cover 20 that is attached to the front side of the housing 10 and that has mating connector inserting openings 24 at positions that correspond to the contact accommodating cavities 13; and a retainer 30 that is attached form the lower side of the housing 10 and that locks contacts accommodated in the contact accommodating cavities 13. Retaining means 27, 28, 32, and 33 is arranged at the front cover 20 and the retainer 30 to cause the retainer 30 to retain the front cover 20.

### TECHNICAL FIELD

The present invention relates to an electrical connector having a housing that has contact accommodating cavities, a front cover that is attached to the front side of the housing and that has inserting openings into which the mating contacts are inserted, at a position opposite to the contact accommodating cavities, and a retainer that locks contacts accommodated in the contact accommodating cavities.

### BACKGROUND ART

Conventionally, there has been known an electrical connector having a housing, a front cover, and a retainer, as shown in FIG. 11 and FIG. 12, for example (see Patent Document 1). FIG. 11 is an exploded perspective view of a conventional electrical connector. FIG. 12 is a partial cross-sectional view of the housing included in the electrical connector.

An electrical connector 101 shown in FIG. 11 is provided with a housing 110, a retainer 120, and a front cover 130.

The housing 110 is formed by molding an insulating resin to have a substantial rectangular parallelepiped shape, and has multiple contact accommodating cavities 111 arranged in two stages in the widthwise direction of the housing 110. Each of the contact accommodating cavities 111 is provided with a housing lance 114 to primarily lock a female contact 116, as shown in FIG. 12. In order to form the housing lances 114, as shown in FIG. 12, a lance forming opening 114a is arranged from the front surface (left-side surface in FIG. 12) of the housing 110 to extend rearward. A retainer accommodating depression 115 is also arranged from the bottom surface of the housing 110 to extend upward. Moreover, the front surface of the housing 110 has a cover accommodating depression 112, and the bottom surface of the cover accommodating depression 112 has a pair of engaging openings 113.

In addition, the retainer 120 is attached to the retainer accommodating depression 115 of the housing 110 from the bottom side of the housing 110, so that the contacts 116 primarily locked by the housing lances 114 are further locked secondarily by terminal locking portions 121 arranged at the front surface of the retainer 120. Pairs of protrusions 123 and 124 are integrally provided at the front upper side and at the rear middle of both of side wall 122 of the retainer 120, respectively. The retainer 120 attached to the retainer accommodating depression 115 is latched in the retainer accommodating depression 115 by the protrusions 123 and 124.

Furthermore, the front cover 130 is attached to the cover accommodating depression 112 of the housing 110 from the front side of the housing 110. The front cover 130 has multiple mating terminal inserting holes 131 located at positions opposite to the contact accommodating cavities 111, respectively. Then, tool openings 132, into which a tool (not shown) for removing the contacts 116 by operating the housing lance 114 is inserted, are respectively arranged below the mating terminal inserting holes 131. Also, a pair of protrusions, not shown, are provided at both sides of the bottom surface of the front cover 130, so that the protrusions are latched by the engaging openings 113 provided at the housing 101.

The front cover 130 is formed separately from the housing 110 as described above, because there are following reasons. To form the housing lances 114 integrally with the housing 110 together with a portion corresponding to the front cover 130, it is necessary to make lance forming openings 114a for inserting molds for forming the housing lances 114 from the front surface of the housing 110 to the housing lances 114. If the housing 110 has a large size and relatively large gaps are ensured between the mating terminal inserting holes 131 adjacently arranged at the front surface of the housing 110, not only the mating terminal inserting holes 131 but also the lance forming openings 114a can be formed from the front surface of the housing 110. However, if the housing 110 is downsized and the gaps between the mating terminal inserting holes 131 adjacently arranged are made smaller at the front surface of the housing 110, it may be impossible to ensure a space for forming the lance forming openings 114a from the front surface of the housing 110. For these reasons, the housing lance 114 is integrally formed with the housing 110, whereas the part in which the mating terminal inserting holes 131 are formed is arranged at the front cover 130 separately provided from the housing 110.

Referring to FIG. 12, without the front cover 130, a mating male terminal 141 provided at a mating connector 140 would be inserted into the lance forming opening 114a or the mating male terminal 141 would reach and touch the contact 116, in some cases, when the mating connector 140 is mated with the electrical connector 110. The provision of the front cover 130 allows the mating male terminal 141 to guide through the mating terminal inserting holes 131 to the contacts 116 in an appropriate manner, and also allows the tool to guide through the tool openings 132 arranged at the front cover 130 to the housing lance 114 in an appropriate manner.

Patent Document 1: JP 2000-315546 A

### DISCLOSURE OF THE INVENTION

It should be noted, however, the electrical connector 101 shown in FIG. 11 and FIG. 12 has the following drawbacks.

That is to say, the front cover 130 is attached to the cover accommodating depression 112 only in a case where a pair of protrusions (not shown) arranged at both sides of the bottom surface are latched by the engaging latch openings 113 provided at the housing 110. Accordingly, the retaining force of retaining the front cover 130 is very weak. For this reason, if the electrical connector 101 is dropped off, or if the mating connector 140 is removed after the electrical connector 101 and the mating connector 140 are mated with each other, the front cover 130 will come off from the housing 110 in some cases.

Meanwhile, the number of the protrusions provided at the front cover 130 and the number of the engaging openings 113 provided at the housing 110 are increased for enhancing the retaining force of retaining the front cover 130. However, if the number of the protrusions provided at the front cover 130 and the number of the engaging openings 113 provided at the housing 110 are increased, the front cover 130 and the housing 110 will be upsized. This goes against the need for downsizing the whole electrical connector 101. Therefore, in the electrical connector 101 shown in FIG. 11 and FIG. 12, it is impossible to arrange at the front cover 130 and the housing 110 a number of members for locking the front cover 130 to the housing 110.

The present invention has been made in view of the above circumstances and has an object of the present invention is to provide an electrical connector including: a housing having contact accommodating cavities; a front cover that is attached to the front side of the housing and that has mating connector inserting openings at positions that correspond to the contact accommodating cavities; and a retainer that is attached form the lower side of the housing and that locks contacts accommodated in the contact accommodating cavities, wherein retaining means is arranged at the front cover and the retainer to cause the retainer to retain the front cover.

The electrical connector according to claim 1, wherein the retaining means includes: front cover retaining protrusions arranged at the upper end surface of the retainer; and openings that are arranged at the upper wall of the front cover and that regulates the front-rear movement of the front cover after the front cover retaining protrusions are inserted through the openings when the retainer is attached to the housing.

The electrical connector according to claim 1 or claim 2, wherein the retaining means includes: projecting portions that are arranged at the lower part of both of side walls of the front cover; and retaining portions that are arranged at the lower part of both of side walls in the retainer that retain the projecting portions, when the retainer is attached to the housing, so as to regulate a front-rear movement of the front cover.

According to the electrical connector recited in claim 1, the retaining means that causes the retainer to retain the front cover is arranged at the front cover and the retainer, so the front cover attached to the housing is retained by the retainer by use of the retaining means arranged at the front cover and the retainer, thereby increasing the retaining force of retaining the front cover. Therefore, this reduces the possibility that the front cover will come off from the housing, if the electrical connector is dropped off or when the mating connector is removed after the mating connector and the electrical connector are mated with each other. In addition, the front cover is retained by the retaining means by use of the retainer, thereby downsizing of the entire electrical connector. Further, lots of members for locking the front cover to the inner housing can be arranged at the front cover and the inner housing, thereby improving the retaining force of retaining the front cover. Moreover, multiple members for locking the front cover to the inner housing can be disposed in different directions from each other, thereby improving the retaining forces in various directions.

According to the electrical connector as recited in claim 2, in the electrical connector recited in claim 1, the retaining means includes: front cover retaining protrusions arranged at the upper end surface of the retainer; and openings that are arranged at the upper wall of the front cover and that regulates the front-rear movement of the front cover after the front cover retaining protrusions are inserted through the openings when the retainer is attached to the housing. Accordingly, the front cover retaining protrusions of the retainer attached to the housing are inserted through the openings defined at the front cover, thereby regulating the front-and-rear movement of the front cover and further improving the retaining force of retaining the front cover.

According to the electrical connector as recited in claim 3, in the electrical connector recited in claim 1 or claim 2, the retaining means includes: projecting portions that are arranged at the lower part of both of side walls of the front cover; and retaining portions that are arranged at the lower part of both of side walls in the retainer that retain the projecting portions, when the retainer is attached to the housing, so as to regulate a front-rear movement of the front cover. Accordingly, the retaining portions respectively retain the projecting portions, thereby regulating the front-rear movement of the front cover and further improving the retaining force of retaining the front cover.

### BRIEF DESCRIPTION OF THE DRAWINGS

FIG. 1 is an exploded perspective view illustrative of an electrical connector according to an aspect of the present invention;

FIGS. 2A and 2B illustrate the electrical connector of FIG. 1, FIG. 2A illustrates a state before the mating connector is mated, and FIG. 2B illustrates a state after the mating connector is mated;

FIGS. 3A and 3B illustrate the electrical connector of FIG. 1, FIG. 3A illustrates a font view, and FIG. 3B illustrates a cross-sectional view taken along a ling 3B-3B of FIG. 3A;

FIGS. 4A and 4B illustrate the electrical connector of FIG. 1, FIG. 4A illustrates a cross-sectional view taken along a line 4A-4A, and FIG. 4B illustrates a cross-sectional view taken along a ling 4B-4B of FIG. 4A;

FIGS. 5A and 5B illustrate an inner housing, FIG. 5A illustrates a back view, and FIG. 5B illustrates a bottom view;

FIGS. 6A to 6C illustrate the inner housing of FIG. 5B, FIG. 6A illustrates a cross-sectional view taken along a line 6A-6A of FIG. 5B, FIG. 6B illustrates a cross-sectional view taken along a line 6B-6B of FIG. 5B, and FIG. 6C illustrates a partial enlarged view of FIG. 5B;

FIGS. 7A to 7D illustrate a front cover, FIG. 7A illustrates a back view, FIG. 7B illustrates a cross-sectional view taken along a line 7B-7B of FIG. 7A, FIG. 7C illustrates a cross-sectional view taken along a line 7C-7C of FIG. 7A, and FIG. 7D illustrates a cross-sectional view taken along a line 7D-7D of FIG. 7A;

FIG. 8 illustrates an exploded perspective view according to a variation of the electrical connector;

FIGS. 9A to 9C illustrate the electrical connector of FIG. 8 in a state where a retainer is located at a temporary position, FIG. 9A illustrates a cross-sectional view the electrical connector cut away from the side surface side (cross-sectional view that is cut away from a line same as the line 4B-4B of FIG. 3A), FIG. 9B illustrates a cross-sectional view of the connector cut away from the front surface side, and FIG. 9C illustrates a cross-sectional view of the connector cut away from the flat surface side;

FIGS. 10A and 10B illustrate the electrical connector of FIG. 8 in a state where a retainer is located at a proper locking position, FIG. 10A illustrates a cross-sectional view the electrical connector cut away from the side surface side, and FIG. 10B illustrates a cross-sectional view of the connector cut away from the front surface side;

FIG. 11 illustrates an exploded perspective view of a conventional electrical connector; and

FIG. 12 is a partial cross-sectional view of a housing included in the electrical connector of FIG. 11.

### EXPLANATION OF REFERENCES

1, 1′ electrical connector

10 inner housing

13 contact accommodating cavity

20 front cover

22 hood portion

22a upper wall

22b side wall

24 mating terminal inserting openings

27 opening

28 projecting portion

30 retainer

30a upper end surface

30b side wall

32 front cover retaining protrusion

33 retaining portion

### BEST MODE FOR CARRYING OUT THE INVENTION

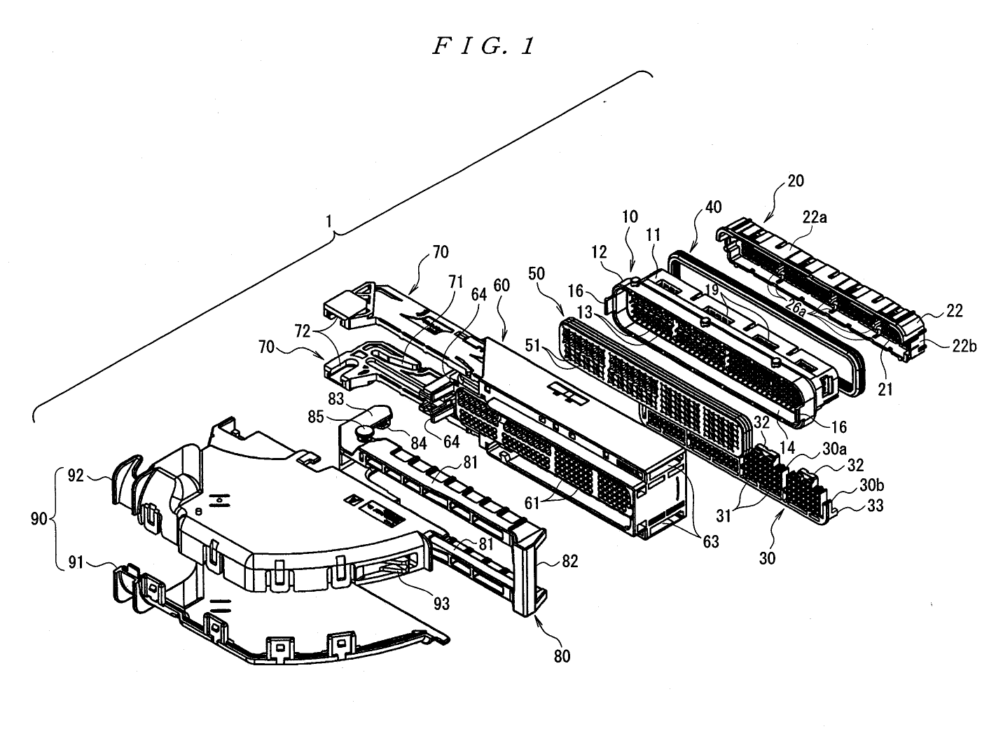

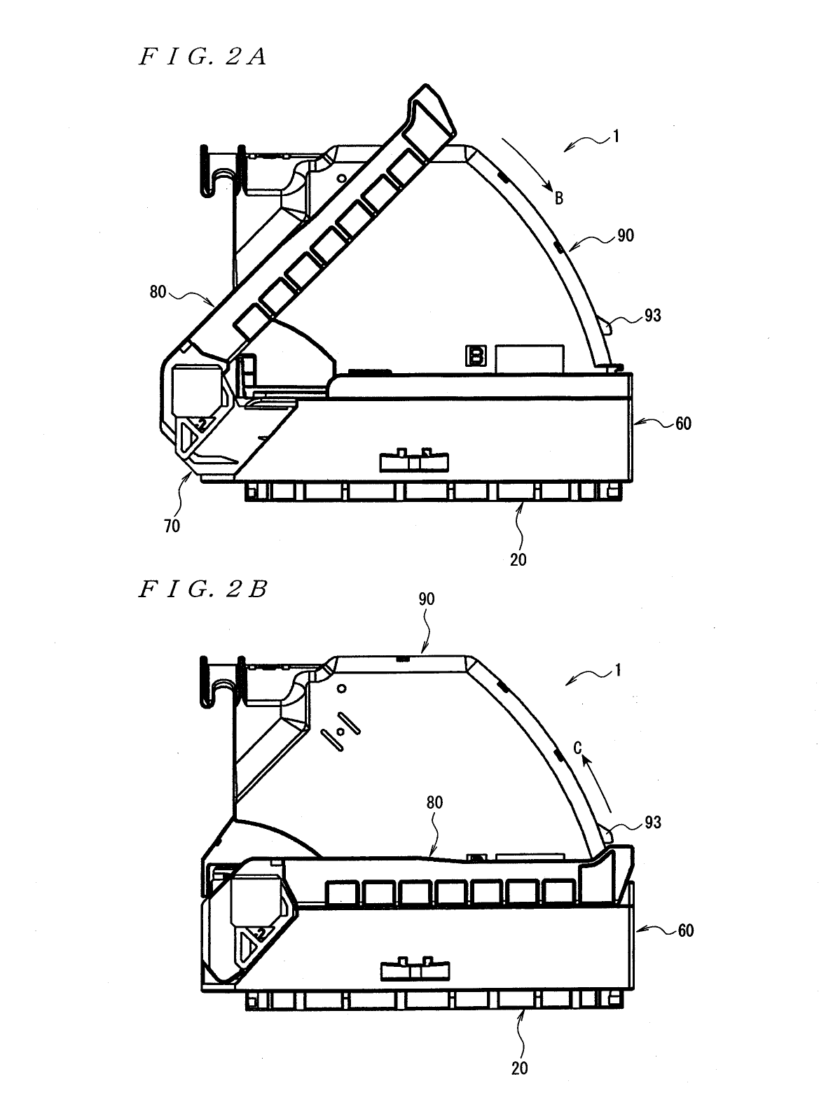

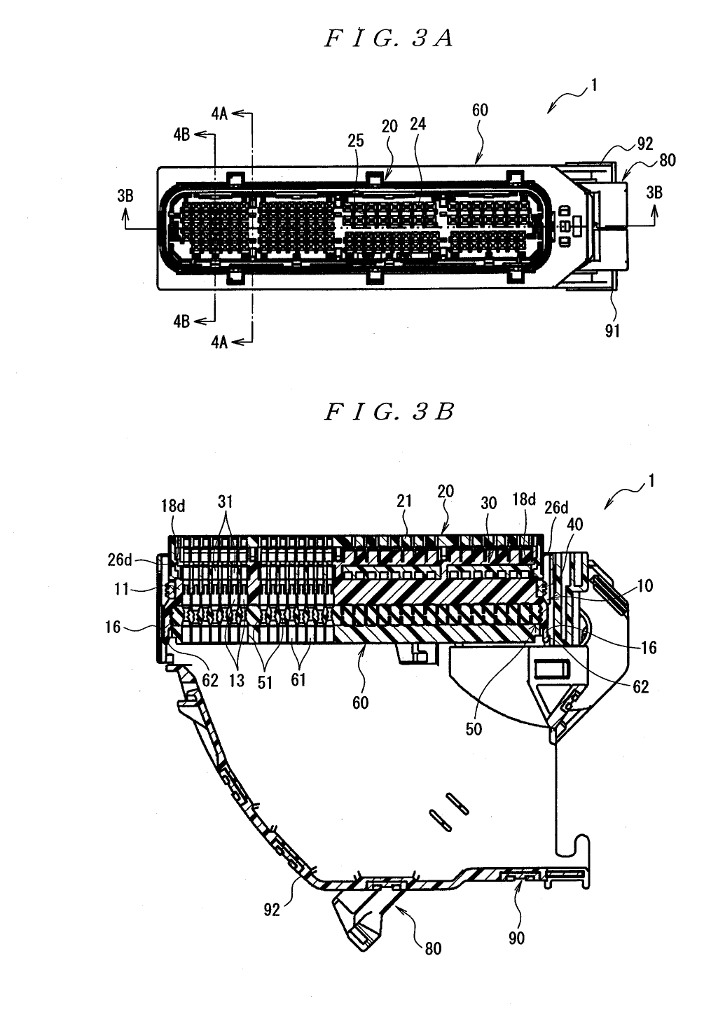

The embodiments of the present invention will now be described based on the accompanying drawings. FIG. 1 is an exploded perspective view illustrative of an electrical connector according to an aspect of the present invention. FIGS. 2A and 3B illustrate the electrical connector of FIG. 1, FIG. 2A illustrates a state before the mating connector is mated, and FIG. 2B illustrates a state after the mating connector is mated. FIGS. 3A and 3B illustrates the electrical connector of FIG. 1, FIG. 3A illustrates a font view, an FIG. 3B illustrates a cross-sectional view taken along a ling 3B-3B of FIG. 3A.

An electrical connector 1 illustrated in FIG. 1 is what is called a lever-type connector, and is provided with: an inner housing 10 (housing recited in claim 1); a front cover 20; a retainer 30; a first sealing member 40; a second sealing member 50; an outer housing 60; a pair of sliders 70; a lever 80; and a wire cover 90.

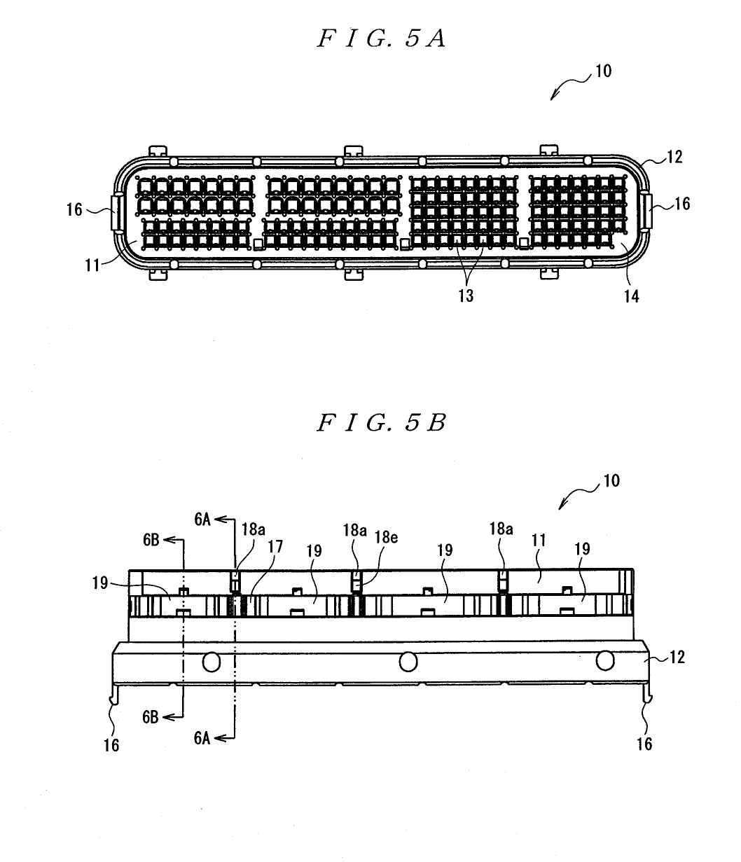

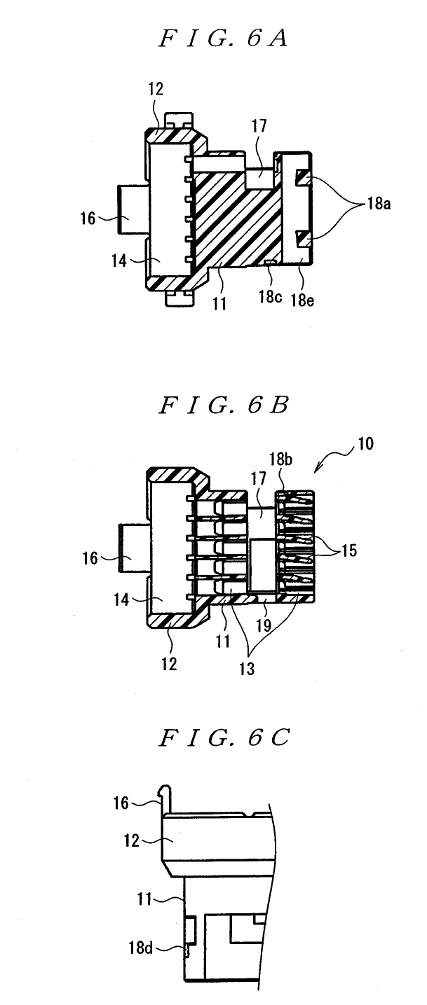

FIGS. 5A and 5B illustrate an inner housing, FIG. 5A illustrates a back view, and FIG. 5B illustrates a bottom view. FIGS. 6A to 6C illustrate the inner housing of FIG. 5B, FIG. 6A illustrates a cross-sectional view taken along a line 6A-6A of FIG. 5B, FIG. 6B illustrates a cross-sectional view taken along a line 6B-6B of FIG. 5B, and FIG. 6C illustrates a partial enlarged view of FIG. 5B.

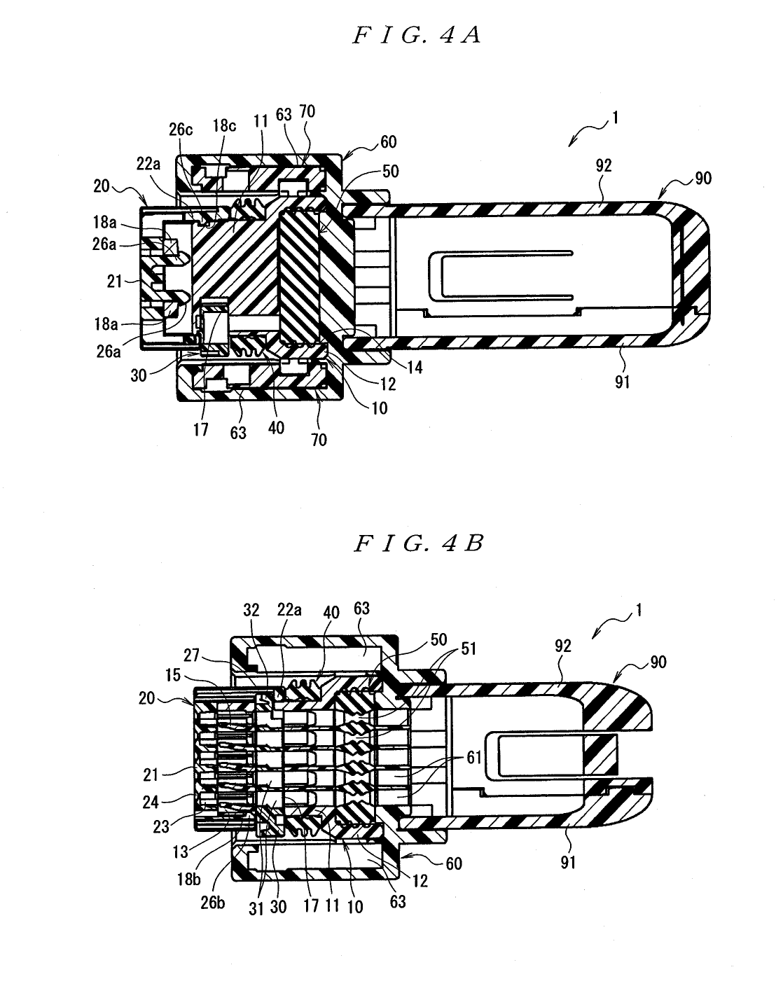

The inner housing 10 is integrally formed by molding an insulating resin. As illustrates in FIG. 1, FIG. 4 to FIG. 6, the inner housing 10 is provided with: a housing main body 11 having a substantial rectangular parallelepiped shape that extends in the widthwise direction (horizontal direction of FIG. 5A), in the vertical direction (up-and-down direction of FIG. 5A), and in the front-rear direction (up-and-down direction of FIG. 5B); and a hood portion 12 that extends rearward from the housing main body 11. The housing main body 11 has multiple contact accommodating cavities 13 that penetrate through the housing main body 11 in the front-rear direction. An inner space of the hood portion 12 defines a second sealing member accommodating space 14. Each of the contact accommodating cavities 13 is provided with a housing lance 15 for primarily locking a contact, not illustrated.

Then, the housing main body 11 is provided with a retainer accommodating depression 17 that opens downward and extends upward (opens upward in FIG. 6) as illustrated in FIG. 4A, FIG. 4B, FIG. 6A, and FIG. 6B. The top surface of the retainer accommodating depression 17 has multiple openings 19, as illustrated in FIG. 1, FIG. 5B, and FIG. 6B. Front cover retaining protrusions 32, to be described later, of the retainer 30 penetrate through the openings 19, respectively, and protrude above the upper side of the housing main body 11.

Also, a pair of latch arms 16 for latching the inner housing 10 with the outer housing 60 are provided to protrude rearward at both end portions in the widthwise direction of the hood portion 12 in the inner housing 10, as illustrated in FIG. 1. On the other hand, the front surface of the housing main body 11 of the inner housing 10 is provided with multiple grooves 18e that penetrate through in up-and-down direction, as illustrated in FIG. 5B and FIG. 6A. The front end portion of each groove 18e is provided with a pair of latching portions 18a to be latched by elastic latch arms 26a provided at the front cover 20 and arranged at a given interval in the up-and-down direction, as illustrated in FIG. 4A. Each of the latching portions 18a is arranged to cross the depression 18e. In addition, the front side of the retainer accommodating depression 17 of the housing main body 11, that is, the bottom surface of the housing main body 11, is provided with multiple cutouts 18b with which elastic latch arms 26b provided at the front cover 20 is latched, as illustrated in FIG. 4B and FIG. 6B. Furthermore, the top surface of the housing main body 11 has the depression 18c into which a projection 26c arranged at the front cover 20 enters, as illustrated in FIG. 4A and FIG. 6A. Moreover, both side walls in the widthwise direction of the housing main body 11 have locking depressions 18d to be respectively locked by elastic side locks 26d arranged at the front cover 20.

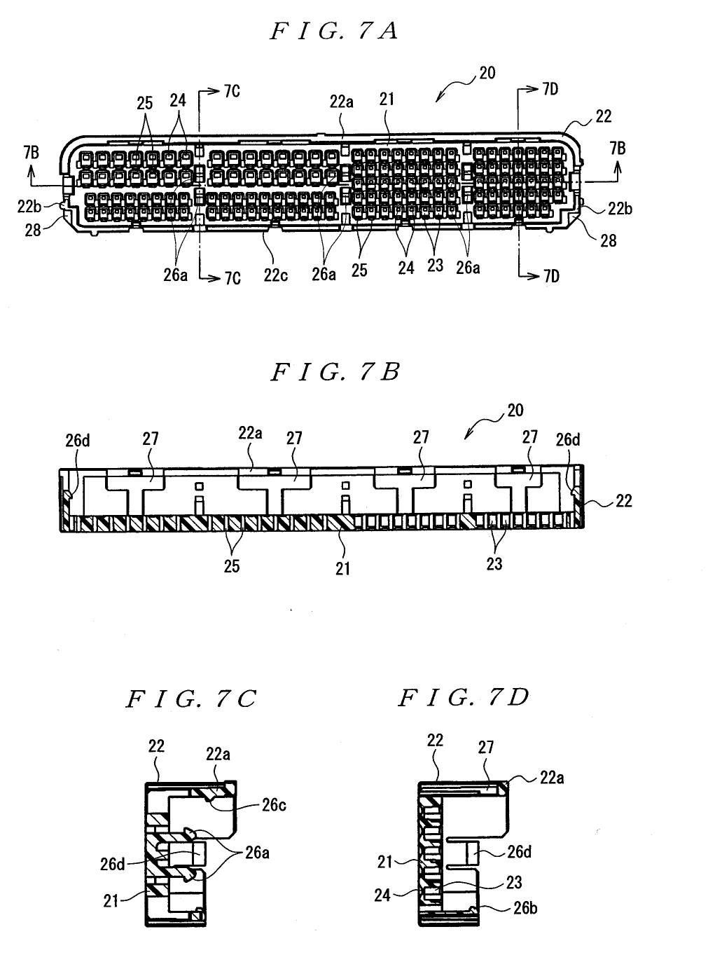

FIGS. 7A to 7D illustrate a front cover, FIG. 7A illustrates a back view, FIG. 7B illustrates a cross-sectional view taken along a line 7B-7B of FIG. 7A, FIG. 7C illustrates a cross-sectional view taken along a line 7C-7C of FIG. 7A, and FIG. 7D illustrates a cross-sectional view taken along a line 7D-7D of FIG. 7A.

The front cover 20 is attached to the front side of the inner housing 10. As illustrated in FIG. 1, FIG. 7A, FIG. 7B, and FIG. 7C, the front cover 20 is provided with a cover main body 21 that extends in the widthwise direction to cover the front surface of the housing main body 11. The front cover 20 is formed by molding an insulating resin. The rear surface of the cover main body 21 has a hood portion 22 that extends rearward to cover the top surface of the housing main body 11 and both side surfaces in the widthwise direction of the housing main body 11.

In this situation, the rear surface of the cover main body 21 of the front cover 20, as illustrated in FIG. 4B, FIG. 7A and FIG. 7D, multiple contact accommodating chambers 23 are defined at positions that correspond to the contact accommodating cavities 13 defined at the housing main body 11. In addition, the front surface of the cover main body 21 has multiple mating terminal inserting openings 24 that communicate with the contact accommodating chambers 23, respectively, at positions that correspond to the contact accommodating cavities 13 defined in the housing main body 11. Furthermore, tool openings 25, into which a tool (not illustrated) for removing the contacts (not illustrated) by operating the housing lance 15, are arranged at the front surface of the cover main body 21 and below the mating terminal inserting openings 24, respectively.

The provision of the front cover 20 allows the electrical connector 1 to be downsized, and additionally avoids the drawbacks including that the mating terminals provided at the mating connector touch the contacts when the mating connector (not illustrated) and the electrical connector 1 are mated with each other. That is to say, it is possible to protect the contacts accommodated in the inner housing 10.

The cover main body 21 of the front cover 20 is provide with multiple pairs of elastic latch arms 26a that protrude rearward at a given interval in the widthwise direction. Each pair of the elastic latch arms 26a, as illustrated in FIG. 4A, are inserted between each pair of the latching portions 18a to be latched by the latching portions 18a. Each pair of the elastic latch arms 26a are arranged at a given interval in the up-and-down direction. In addition, the lower part of the cover main body 21 in the front cover 20 is provided with multiple elastic latch arms 26b to be latched by the cutouts 18b arranged in the inner housing 10, as illustrated in FIG. 4B and FIG. 7D. Furthermore, an upper wall 22a of the hood portion 22 in the front cover 20 is provided with the projection 26c to be inserted into the depression 18c arranged at the inner housing 10, as illustrated in FIG. 4A and FIG. 7C. Moreover, both side walls of the hood portion 22 in the front cover 20 are provided with a pair of elastic side locks 26 to be locked by the locking depressions 18d of the inner housing 10.

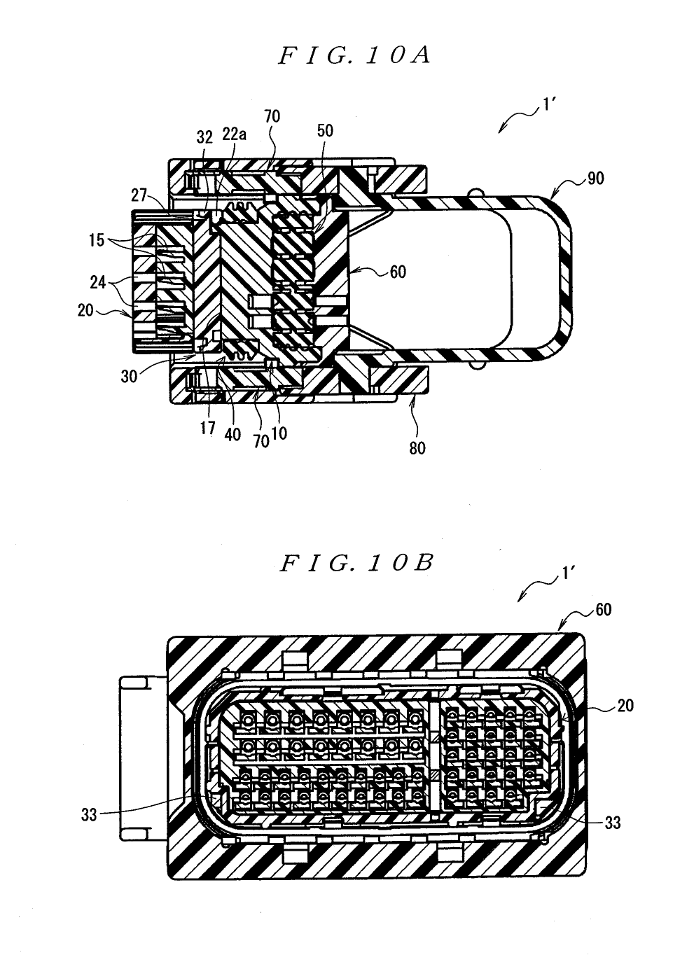

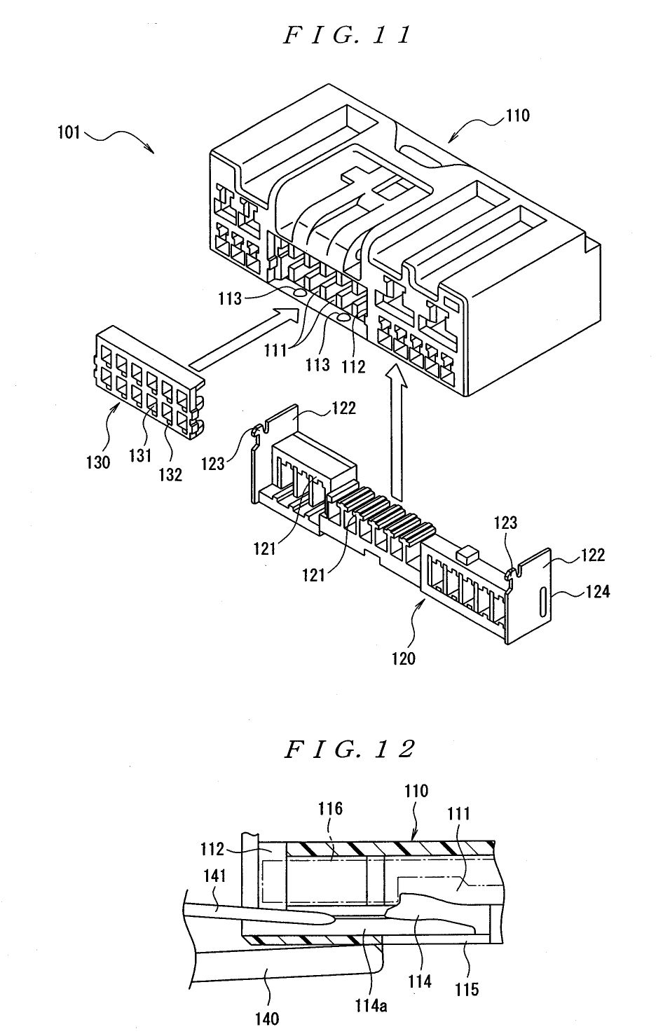

Further, the upper wall 22a of the hood portion 22 in the front cover 20 is provided with multiple openings 27 through which the front cover retaining protrusions 32, to be described later, of the retainer 30 are inserted, respectively, as illustrated in FIG. 4B and FIG. 7B. Into each of the multiple openings 27, the front cover retaining protrusions 32 are penetrated through the multiple openings 27, respectively, when the retainer 30 is attached to the housing 10, so as to regulate the front-rear movement of the front cover 20, as illustrated in FIG. 10A (FIGS. 10A and 10B illustrate a variation of the electrical connector 1 with the openings 27 having the same functions). Also, projecting portions 28 that project outward are arranged at the lower part of both of side walls 22b of the hood portion 22 in the front cover 20, as illustrated in FIG. 7A.

Next, the retainer 30 is attached to the retainer accommodating depression 17 from the lower side of the inner housing 10, and is formed to have a substantial plate shape that extends in the widthwise direction, as illustrated in FIG. 1, FIG. 4A and FIG. 4B. The retainer 30 is temporarily locked by the inner housing 10 at a temporary locking position of FIG. 4A and FIG. 4B. Subsequently, the retainer 30 is further pushed from the temporary locking position, and properly locks contacts (not illustrated) in the inner housing 10 at a proper locking position (not illustrated). The proper locking state of the retainer 30 denotes a state where the retainer 30 is completely pushed into the inner housing 10.

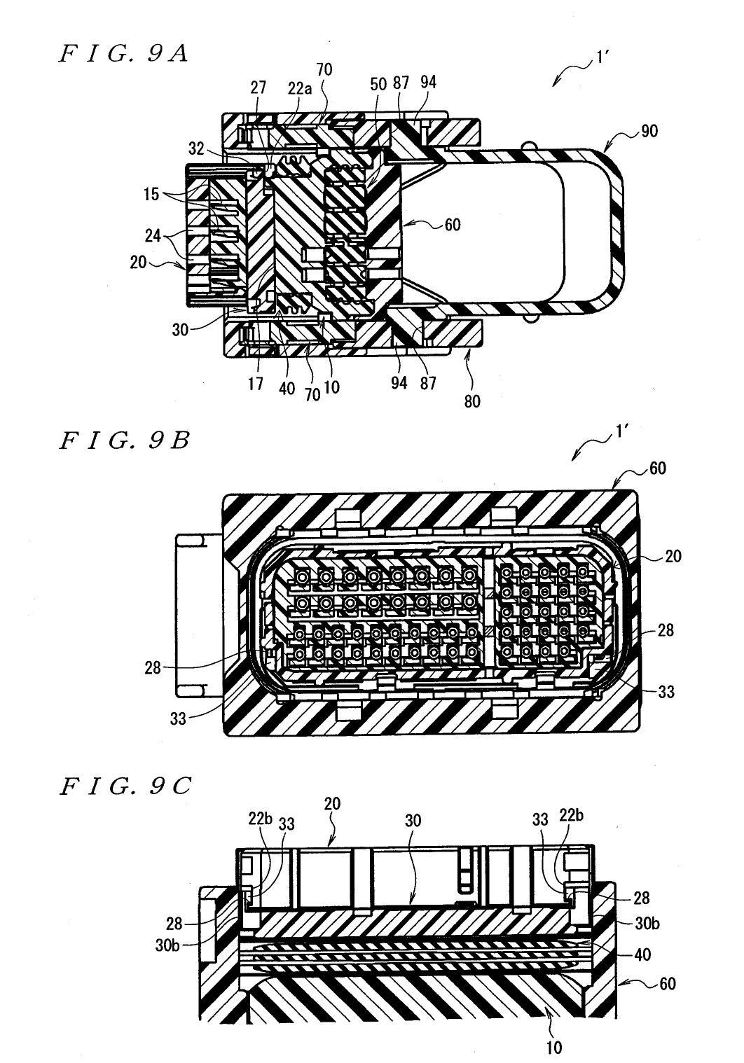

The retainer 30 is formed by molding an insulating resin, and includes multiple contact inserting openings 31 to correspond to the contact accommodating cavities 13, respectively, arranged at the housing main body 11. An upper end surface 30a of the retainer 30 is provided with multiple front cover retaining projections 32 to project upward. Also, a pair of retaining portions 33 are arranged at the lower part of both of side walls 30b in the retainer 30, as illustrated in FIG. 1 (only one retaining portion 33 provided at one of side walls is illustrated in FIG. 1). These retaining portions 33 retain the projecting portions 28, when the retainer 30 is attached to inner housing 10, so as to regulate the front-rear movement of the front cover 20, as illustrated in FIG. 9B and FIG. 9C (FIGS. 9A to 9C illustrate a variation of the electrical connector 1 with the retaining portions 33 having the same functions).

Herein, the front cover retaining protrusions 32 provided at the retainer 30, the openings 27 arranged at the upper wall 22a in the front cover 20, the projecting portions 28 arranged at the lower part of both of the side walls 22b in the front cover 20, and the retaining portions 33 arranged at the lower part of both of the side walls 30b of the retainer 30 constitute “retaining means” recited in claim 1.

When the retainer 30 is located at the temporary locking position, the contacts, not illustrated, are inserted into the contact accommodating cavities 13, respectively, so that the contacts are primarily locked by the housing lance 15. Then, when the retainer 30 is made to move to the proper locking position, the contacts are secondarily locked to the inner housing 10 by the retainer 30.

Also, the first sealing member 40 is formed to have a ring shape, as illustrated in FIG. 1, FIG. 4A, and FIG. 4B, to be tightly attached to the exterior of the housing main body 11 in the inner housing 10. When the mating connector (not illustrated) is mated with the electrical connector 1, the first sealing member 40 seals between the mating connector and the housing main body 11, and has a function of preventing water from entering into the inner housing 10 from the mating portion.

In addition, the second sealing member 50 is formed to have a substantial plate shape, as illustrated in FIG. 1, FIG. 4A, and FIG. 4B, to be accommodated in a second sealing member accommodating space 14 of the hood portion 12 in the inner housing 10, and is tightly attached to the inner circumferential surface of the hood portion 12. Multiple electrical wire inserting openings 51 are defined at the second sealing member 50, as illustrated in FIG. 1 and FIG. 4B, at positions that correspond to the contact accommodating cavities 13, respectively. Electric wires (not illustrated) connected to the contacts accommodated in the contact accommodating cavities 13 are extended rearward via the electrical wire inserting openings 51. However, the sealed part in the inner circumference of the electrical wire inserting opening 51 is tightly attached to the external circumferential surface of the electrical wire so as to prevent water from entering into the inner housing 10 from the electrical wire inserting opening 51.

Furthermore, the outer housing 60 is integrally formed by molding an insulating resin to have a substantial rectangular parallelepiped shape that extends in the widthwise direction, in the up-and-down direction, and in the front-rear direction, as illustrated in FIG. 1. Multiple electrical wire extending openings 61 are defined at the outer housing 60 at positions that correspond to the contact accommodating cavities 13, as illustrated in FIG. 4B. Additionally, a pair of slider accommodating groves 63 that extend in the widthwise direction are defined at both of up and down sides of the outer housing 60, as illustrated in FIG. 4B. Further, as illustrated in FIG. 3B, there is provided at the rear surface of the outer housing 60 a step portion for engagement 62 to be engaged by the latch arms 16 provided in the inner housing 10.

Moreover, each of the sliders 70 is formed to have a substantial plate shape, and is movably accommodated in the slider accommodating grove 63 of the outer housing 60. A cam groove 71 is defined at the inner surface of each slider 70, as illustrated in FIG. 1, so that a cam pin (not illustrated) is provided at the mating connector to enter into the cam groove 71. Also, depressions 72 are defined at one end portion of the inner surface of each slider 70, so that a protrusion for slider movement 85, to be described later, arranged at the lever 80 is fit into the depressions 72.

Moreover, as illustrated in FIG. 1, the lever 80 is provided with: a pair of arm portions 81; and a connecting portion 82 that connect one ends of the arm portions 81 with each other. Each of the other ends of the arm portions 81 is provided with an extending portion 83 that extends orthogonally, and a pivot 84 is formed to protrude at the inner surface of an end of each extending portion 83. Also, the external surface of the other end of each of the arm portions 81 is provided with the protrusion for slider movement 85 that is fit into the depression 72 of each slider 70. The pivot 84 of the lever 80 is fit into a pivot receiving portion 64 arranged at one end portion in the widthwise direction of the outer housing 60 to turn the lever 80 both in an arrow B direction illustrated in FIG. 2A and in an arrow C direction illustrated in FIG. 2B, with respect to the outer housing 60. When the lever 80 turns in the arrow B direction, the sliders 70 move in a direction where the sliders 70 are accommodated in the slider accommodating groves 63 of the outer housing 60. Conversely, when the lever 80 moves in the arrow C direction, the sliders 70 move in a direction where the sliders 70 come out of the slider accommodating groves 63. When the lever 80 turns in the arrow B direction from the state illustrated in FIG. 2A and then the sliders 70 arranged at the mating connector move in the direction where the sliders 70 are accommodated in the slider accommodating groves 63, the cam pin provided at the mating connector is pulled to the electrical connector 1 side along the cam grooves 71 of the sliders 70 so that the mating connector is mated with the electrical connector 1. Conversely, when the lever 80 turns in the arrow C direction from the state illustrated in FIG. 2B and then the sliders come out of the slider accommodating groves 63, the cam pin provided at the mating connector moves in the direction of moving away from the electrical connector 1 and then mating of the mating connector and the electrical connector 1 is released.

Furthermore, the wire cover 90 includes: a lower cover member 91; and an upper cover member 92 that is attached to the lower cover member 91, as illustrated in FIG. 1. The wire cover 90 is attached to the rear side of the outer housing 60, so that multiple electrical wires extended from the electrical wire extending openings 61 of the outer housing 60 are further extended to one side in the widthwise direction of the outer housing 60. As illustrated in FIG. 2B, the upper cover member 92 is provided with a lock member 93 that prevents the lever 80 from turning in the arrow C direction, when the lever 80 turns in the arrow B direction and is then located at the final position.

Next, an assembling method of the electrical connector 1 will be described.

At the time of initiating the assembling of the electrical connector 1, the first sealing member 40 is firstly attached to the exterior of the housing main body 11 of inner housing 10.

Subsequently, the front cover 20 is attached to the front side of inner housing 10. In this situation, as illustrated in FIG. 4A, each pair of the elastic latch arms 26a arranged at the front cover 20 are inserted between each pair of the latching portions 18a arranged at the inner housing 10, and are then latched by the latching portions 18a, respectively. Also, as illustrated in FIG. 4A, the projection 26c arranged at the front cover 20 enters into the depression 18c arranged at the inner housing 10. In addition, as illustrated in FIG. 4B, the elastic latch arms 26b arranged at the front cover 20 are latched by the cutouts 18b arranged at the inner housing 10. Furthermore, as illustrated in FIG. 3B, the elastic side locks 26d arranged at the front cover 20 are locked by the locking depressions 18d of the inner housing 10.

Then, the retainer 30 is inserted into the retainer accommodating depression 17 from the bottom side of the housing 10, so as to be locked by the housing 10 at the temporary locking position, as illustrated in FIG. 4A and FIG. 4B. When the retainer 30 is locked at the temporary locking position, the contact inserting openings 31 are located at positions in alignment with the contact accommodating cavities 13. Also, in this situation, the front cover retaining protrusions 32 of the retainer 30 penetrate through the openings 19, respectively, of the inner housing 10 as illustrated in. FIG. 4B, and is additionally inserted through the openings 27 of the front cover 20 to regulate the movement in the front-rear direction of the front cover 20. Further, in this case, the retaining portions 33 of the retainer 30 retain the projecting portions 28 arranged at the front cover 20, as illustrated in FIG. 9B and FIG. 9C, to regulate the front-rear movement of the front cover 20.

Next, the second sealing member 50 is accommodated in the hood portion 12 from the rear side of the inner housing 10. This tightly attaches the external circumferential surface of the second sealing member 50 to the inner circumferential surface of the hood portion 12.

Subsequently, the inner housing 10 to which the first sealing member 40, the front cover 20, the retainer 30, and the second sealing member 50 are attached is attached to the outer housing 60. In this case, the latch arms 16 provided in the inner housing 10 are latched by the step portion for engagement 62 of the outer housing 60.

Then, a pair of sliders 70 are inserted into the slider accommodating groves 63 from the depressions 72 arranged at one end portion and at the opposite end portion.

Next, the pivot 84 of the lever 80 is fit into the pivot receiving portion 64 arranged at one end portion in the widthwise direction of the outer housing 60, and simultaneously, the protrusion for slider movement 85 of the lever 80 is fit into the depression 72 of each slider 70. This causes the lever 80 to be movable both in the arrow B direction illustrated in FIG. 2A and in the arrow C direction illustrated in FIG. 2B, with respect to the outer housing 60, and also causes the sliders 70 to be movable in the slider accommodating groves 63, respectively, in accordance with the turning operation of the lever 80.

Then, multiple contacts connected to the electrical wires are accommodated in the contact accommodating cavities 13 of the inner housing 10, respectively, through the electrical wire extending openings 61 and the electrical wire inserting openings 51 of the second sealing member 50 from the rear side of the outer housing 60. In this situation, the housing lance 15 provided at the inner housing 10 primarily locks each contact.

Subsequently, the retainer 30 is further pushed from the temporary locking position and is locked to the inner housing 10 at the proper locking position. Accordingly, the contacts are secondarily locked to the inner housing 10 by the retainer 30. In this situation, the front cover retaining protrusions 32 of the retainer 30 are inserted through the openings 27 of the front cover 20 to regulate the front-rear movement of the front cover 20. Also, in this case, the retaining portions 33 of the retainer 30 retain the projecting portions 28 arranged at the front cover 20 to regulate the front-rear movement of the front cover 20, as illustrated in FIG. 10B.

Lastly, the wire cover 90 is attached to the rear side of the outer housing 60, so that multiple electrical wires extended from the electrical wire extending openings 61 of the outer housing 60 are further extended to one side of the longitudinal direction of the outer housing 60.

By the above operation, the assembling of the electrical connector 1 is completed.

Herein, as described above, the front cover 20 is retained by the inner housing 10 by means of the locking force of the elastic latch arms 26a arranged at the front cover 20, the locking force of the projection 26c arranged at the front cover 20, the locking force of the elastic latch arms 26b arranged at the front cover 20, and the locking force of the elastic side locks 26d arranged at the front cover 20. In addition to the locking forces of the above members, the front cover 20 is retained by the retainer 30 by means of the retaining means arranged at the front cover 20 and the retainer 30. It is therefore possible to increase the retaining force of retaining the front cover 20 as compared to a case where the front cover 20 is retained by only the retaining forces described above. Accordingly, if the electrical connector 1 is dropped off, or when the mating connector is removed after the mating connector and the electrical connector 1 are mated with each other, it is possible to reduce a possibility that the front cover 20 will come off from the inner housing 10.

Then, the retaining means is provided with: the front cover retaining protrusions 32 arranged at the retainer 30; and the openings 27 that are arranged at the upper wall 22a of the front cover 20 and that regulates the front-rear movement of the front cover 20 after the front cover retaining protrusions 32 are inserted through the openings 27 when the retainer 30 is attached to the inner housing 10. For this reason, the front cover retaining protrusions 32 of the retainer 30 attached to the inner housing 10 are inserted through the openings 27 defined at the front cover 20, thereby regulating the front-rear movement of the front cover 20 and further improving the retaining forces of retaining the front cover 20. That is to say, the lock by use of the elastic latch arms 26a arranged at the front cover 20, the lock by use of the projections 26c arranged at the front cover 20, the lock by use of the 26b arranged at the front cover 20, and the locking by use of the elastic side locks 26d arranged at the front cover 20 are caused by elastic locks by use of the respective members. Therefore, only the above locking force is weak in the retaining force of retaining the front cover 20. If the electrical connector 1 is dropped off, the front cover 20 may be released from the inner housing 10. In contrast, the front cover retaining protrusions 32 of the retainer 30 attached to the inner housing 10 are inserted through the openings 27 defined at the front cover 20 so as to regulate the front-rear movement of the front cover 20, thereby permitting the front cover 20 to be retained in a rigid manner without depending only on the elastic lock. This further improves the retaining force of retaining the front cover 20.

In addition, the retaining means is provided with: the projecting portions 28 arranged at the lower part of both of the side walls 22b of the front cover 20; and the retaining portions 33 that are arranged at the lower part of the side walls 30b in the retainer 30 and that regulate the front-rear movement of the front cover 20 by retaining the projecting portions 28 when the retainer 30 is attached to inner housing 10. Therefore, the retaining portions 33 arranged at the retainer 30 retain the projecting portions 28 arranged at the front cover 20 to regulate the front-rear movement of the front cover 20, thereby further improving the retaining force of retaining the front cover 20. That is to say, the front cover retaining protrusions 32 of the retainer 30 are inserted through the openings 27 defined at the front cover 20 at the upper side of the front cover 20, thereby retaining the front cover 20 in a rigid manner. Conversely, the retaining portions 33 arranged at the retainer 30 retain the projecting portions 28 arranged at the front cover 20 at the lower part of the front cover 20, thereby retaining the front cover 20 in a rigid manner. For these reasons, the retaining force of retaining the front cover 20 is further improved as compared to a case where the front cover retaining protrusions 32 of the retainer 30 are merely inserted through the openings 27 defined at the front cover 20 at the upper side of the front cover 20 so that the front cover 20 is retained in a rigid manner.

Then, the front cover 20 is retained by the retaining means by use of the retainer 30, whereby downsizing of the whole electrical connector 1 is achievable.

Also, multiple locking members of locking the front cover 20 to the inner housing 10, including: the elastic latch arms 26a of the front cover 20; the latching portions 18a of the inner housing 10 with which the elastic latch arms 26a are latched; the projection 26c of the front cover 20; the depression 18c of the inner housing 10 with which the projection 26c is locked; the elastic latch arms 26b of the front cover 20, the cutouts 18b of the inner housing 10 with which the elastic latch arms 26b are latched; the elastic side locks 26d of the front cover 20; and the locking depressions 18d of the inner housing 10 with which the elastic side locks 26d are locked, may be arranged at the front cover 20 and the inner housing 10, thereby further improving the locking forces of locking the front cover 20. In addition, the above-described multiple locking members of locking the front cover 20 with the inner housing 10 are disposed at the front cover 20 and the inner housing 10 in different directions from each other, thereby improving the retaining forces in various directions.

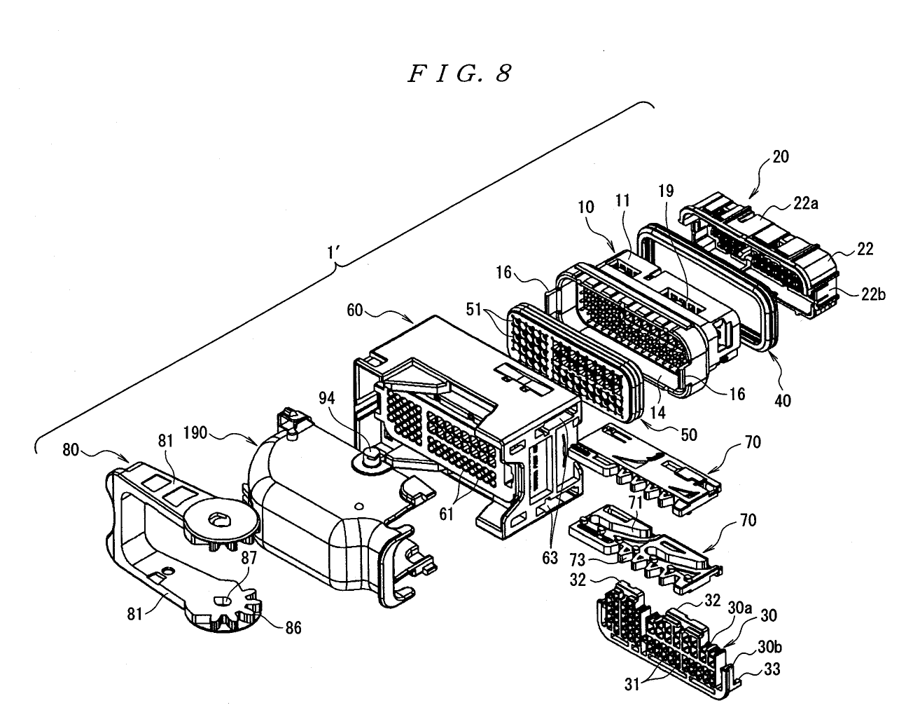

Next, a variation of the electrical connector illustrated in FIG. 1 will be described with reference to FIG. 8 to FIG. 10. FIG. 8 is an exploded perspective view illustrative of a variation of the electrical connector. FIGS. 9A to 9C illustrate the electrical connector of FIG. 8 in a state where a retainer is located at a temporary position, FIG. 9A illustrates a cross-sectional view the electrical connector cut away from the side surface side (cross-sectional view that is cut away from a line same as the line 4B-4B of FIG. 3A), FIG. 9B illustrates a cross-sectional view of the connector cut away from the front surface side, and FIG. 9C illustrates a cross-sectional view of the connector cut away from the flat surface side. FIGS. 10A and 10B illustrate the electrical connector of FIG. 8 in a state where a retainer is located at a proper position, FIG. 10A illustrates a cross-sectional view the electrical connector cut away from the side surface side, and FIG. 10B illustrates a cross-sectional view of the connector cut away from the front surface side.

An electrical connector electrical connector 1′ illustrated in FIG. 8 to FIG. 10 basically has the same configuration as that of the electrical connector 1 illustrated in FIG. 1. However, the electrical connector 1′ has the number of the contacts fewer than that of the electrical connector 1 illustrated in FIG. 1, has a wire cover 190 with a different configuration from that of the electrical connector 1, and has a different configuration for moving the sliders 70 by use of the lever 80 from that of the electrical connector 1. In FIG. 8 to FIG. 10, the same components and configurations as those employed in the electrical connector 1 have the same reference numerals and a detailed explanation will be omitted.

Firstly, the wire cover 190 is different from the wire cover 90 illustrated in FIG. 1. The wire cover 190 is formed by an integrating member, and is provided with a supporting shaft portion 94 for rotatably supporting the lever 80 at its top and bottom surfaces. Each of a pair of the sliders 70 movably accommodated in the slider accommodating groves 63 of the outer housing 60 is provided with racks 73 at its rear end edge. In addition, a shaft opening 87 is defined at the inner surface of an end portion of the arm portion 81 in the lever 80 so that the supporting shaft portion 94 of the wire cover 190 rotatably supports the lever 80. Further, a pinion 86 meshing with the racks 73 of the slider 70 is provided at an end portion of the arm portion 81. The electrical connector 1′ is different from the electrical connector 1 in that the electrical connector 1′ has a rack-and-pinion structure, whereby the sliders 70 are moved by the lever 80.

Incidentally, in the electrical connector 1′, the front cover 20 is retained by the retainer 30 by use of the retaining means arranged at the front cover 20 and the retainer 30. For this reason, if the electrical connector 1′ is dropped off or when the mating connector is removed after the mating connector and the electrical connector 1′ are mated with each other, it is possible to reduce a possibility that the front cover 20 will come off from the inner housing 10.

In addition, like the electrical connector 1, as illustrated in FIG. 9A and FIG. 10A, the retaining means is provided with: the front cover retaining protrusions 32 arranged at the retainer 30; and the openings 27 that is arranged at the upper wall 22a of the front cover 20 and that regulates the front-rear movement of the front cover 20 after the front cover retaining protrusions 32 are inserted through the openings 27 when the retainer 30 is attached to the inner housing 10. For this reason, the front cover retaining protrusions 32 of the retainer 30 attached to the inner housing 10 are inserted through the openings 27 defined at the front cover 20, thereby regulating the front-rear movement of the front cover 20 and further improving the retaining forces of retaining the front cover 20.

Furthermore, like the electrical connector 1, as illustrated in FIG. 9B and FIG. 10B, the retaining means is provided with: the projecting portions 28 arranged at the lower part of both of the side walls 22b of the front cover 20; and the retaining portions 33 that is arranged at the lower part of the side walls 30b in the retainer 30 and that regulates the front-rear movement of the front cover 20 by retaining the projecting portions 28, when the retainer 30 is attached to the inner housing 10. Therefore, the retaining portions 33 arranged at the retainer 30 retain the projecting portions 28 arranged at the front cover 20 to regulate the front-rear movement of the front cover 20, thereby further improving the retaining force of retaining the front cover 20.

As described heretofore, while the embodiments of the present invention have been illustrated in detail, it should be apparent that modifications and adaptations to those embodiments may occur.

For instance, the electrical connector 1 and the electrical connector 1′ have been described as what is called a lever-type electrical connector provided with the lever 80 and the sliders 70. However, the present invention is not limited to the lever-type connector, as long as the electrical connector is provided with: a housing that has contact accommodating cavities; a front cover that is attached to the front side of the housing and that has a front cover with inserting openings into which the mating connector is inserted, at positions opposite to the contact accommodating cavities; and a retainer that locks the contacts accommodated in the contact accommodating cavities.

Also, the retaining means is not limited to that including: the front cover retaining protrusions 32 arranged at the retainer 30; the openings 27 defined at the upper wall 22a of the front cover 20; the projecting portions 28 arranged at the lower part of both the side walls 22b in the front cover 20; and the retaining portions 33 arranged at the lower part of the side walls 30b in the retainer 30, as long as the retaining means is provided with the front cover and the retainer to cause the retainer to retain the front cover.

1. An electrical connector comprising:
a housing having contact accommodating cavities;
a front cover that is attached to the front side of the housing and that has mating connector inserting openings at positions that correspond to the contact accommodating cavities; and
a retainer that is attached form the lower side of the housing and that locks contacts accommodated in the contact accommodating cavities,
wherein retaining means is arranged at the front cover and the retainer to cause the retainer to retain the front cover.

2. The electrical connector according to claim 1, wherein the retaining means includes:
front cover retaining protrusions arranged at the upper end surface of the retainer; and
openings that are arranged at the upper wall of the front cover and that regulates the front-rear movement of the front cover after the front cover retaining protrusions are inserted through the openings when the retainer is attached to the housing.

3. The electrical connector according to claim 1 or claim 2, wherein the retaining means includes:
projecting portions that are arranged at the lower part of both of side walls of the front cover; and
retaining portions that are arranged at the lower part of both of side walls in the retainer that retain the projecting portions, when the retainer is attached to the housing, so as to regulate a front-rear movement of the front cover.
